(19) United States
(12) Patent Application Publication
(10) Pub. No.: US 2011/0176168 A1
(43) Pub. Date: Jul. 21, 2011

(54) INFORMATION PROCESSING APPARATUS, JOB PROCESSING METHOD, AND STORAGE MEDIUM

(75) Inventor: Kenichi Shirai, Ichikawa-shi (JP)

(73) Assignee: CANON KABUSHIKI KAISHA, Tokyo (JP)

(21) Appl. No.: 13/005,397

(22) Filed: Jan. 12, 2011

(30) Foreign Application Priority Data
Jan. 18, 2010 (JP) 2010-007888

(51) Int. Cl. G06F 3/12

(52) U.S. Cl. 358/1.15

(57) ABSTRACT

In an information processing apparatus providing to a client device a portal page in which a plurality of portlets is aggregated, the information processing apparatus, a retaining unit retains print position information for specifying printed information in each of the plurality of portlets and a designation unit designates a print-designated portlet as a print object from the plurality of portlets aggregated in the portal page and a determination unit determines whether unprinted information is contained in information required for printing the print-designated portlet based on the information required for printing the print-designated portlet designated by the designation unit and the print position information and a creation unit creates a print job in such a manner that the unprinted information of the portlet is printed when the determination unit determines that the unprinted information is contained in information required for printing the print-designated portlet.

### BACKGROUND OF THE INVENTION

1. Field of the Invention

The present invention relates to an information processing apparatus that creates a print job from information obtained from a server device in response to a print instruction to a portlet displayed on a client server, a job processing method, and a storage medium.

2. Description of the Related Art

Due to the trend of centralized management such as enhanced internal control, attainment of thin client system is being accelerated in an office environment. Under such environment, an application is formed into software as a service (SaaS), and the number of companies that conduct usual operations on a Web browser is increasing. For example, it is assumed that a user of a client device uses a plurality of portlets such as mail and schedule on one portal system.

In such portal system, in the case of printing information of the portlets displayed on a portal page displayed on the client device, the following two methods are conceivable.

In the first method, the information of the portlets displayed on the portal page displayed on the client device is printed by using a print function of the Web browser. In the second method, it is necessary to perform a print instruction for the information of the portlets displayed on the portal page displayed on the client device.

There are issues that the information which is not required by the user is also printed according to the first method, and that the print instruction by the user takes time and labor according to the second method.

In order to solve the issues, Japanese Patent Application Laid-Open No. 2000-172461 proposes a system for causing, when a print instruction for a plurality of data files is given at once, an application that is associated with each of the data files to perform printing.

However, printed information can be printed again in some cases by the method discussed in Japanese Patent Application Laid-Open No. 2000-172461.

### SUMMARY OF THE INVENTION

The present invention is directed to a system that is capable of printing unprinted information of a portlet with a simple user's operation.

According to an aspect of the present invention, an information processing apparatus providing to a client device a portal page in which a plurality of portlets is aggregated, includes a retaining unit configured to retain print position information for specifying printed information in each of the plurality of portlets, a designation unit configured to designate a print-designated portlet as a print object from the plurality of portlets aggregated in the portal page, a determination unit configured to determine whether unprinted information is contained in information required for printing the print-designated portlet based on the information required for printing the print-designated portlet designated by the designation unit and the print position information, and a creation unit configured to create a print job in such a manner that the unprinted information of the portlet is printed when the determination unit determines that the unprinted information is contained in information required for printing the print-designated portlet.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a portal system.

FIG. 2 a block diagram illustrating a system configuration of a portal server.

FIG. 3 is a block diagram illustrating a system configuration of a Web server.

FIG. 4 is a block diagram illustrating a hardware configuration of the portal system.

FIGS. 5A and 5B are diagrams illustrating an example memory map of a random access memory (RAM) illustrated in FIG. 4.

FIG. 6 is a diagram illustrating a screen configuration of a portal system according to an exemplary embodiment.

FIG. 7 is a diagram illustrating an example print setting screen displayed on a display unit.

FIG. 8 is a table illustrating user information retained in a user information database (DB).

FIG. 9 is a flowchart illustrating print processing of an information processing apparatus.

FIG. 10 is a flowchart illustrating print processing of the information processing apparatus.

FIG. 11 is a flowchart illustrating print processing of the information processing apparatus.

### DESCRIPTION OF THE EMBODIMENTS

Various exemplary embodiments, features, and aspects of the invention will be described in detail below with reference to the drawings.

In the present specification, “portal server” is a system server that is intended for effectively searching and using various pieces of data and information spread in a company, and aggregates and displays the information and applications on a Web browser as portlets.

“Portlet” is a detachable user interface that is managed and displayed by a portal site. In the portlet, a part of a markup for displaying Hyper Test Markup Language (HTML) and Extensible Markup Language (XML) is ordinarily displayed.

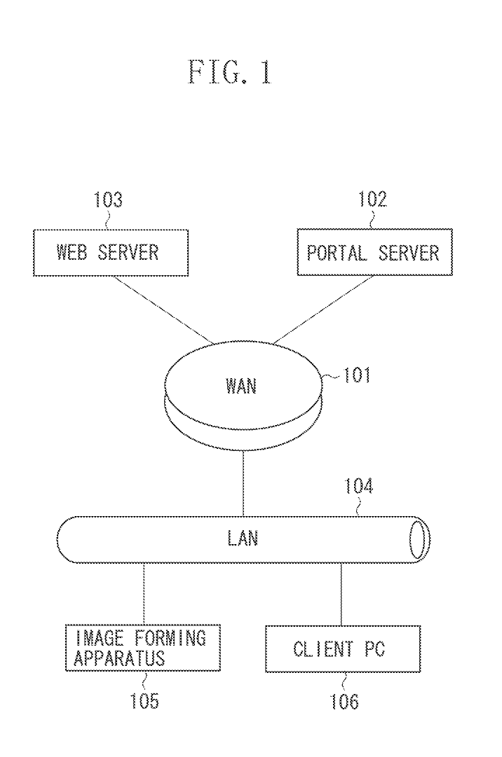

FIG. 1 is a block diagram illustrating a configuration of a portal system including an information processing apparatus according to an exemplary embodiment.

The information processing apparatus of the present exemplary embodiment functions as a portal server that manages a plurality of portlets each of which obtains information including an application through communication with a plurality of Web servers connected via a wide area network (WAN) and provides the information to a client device.

The example in which one Web server 103 is connected is illustrated in FIG. 1 for brevity of description. However, the example has a configuration of being capable of providing a plurality of applications and information managed by a plurality of Web servers to a user of the client server as one portlet.

As illustrated in FIG. 1, the portal system includes server computers such as a Web server 103 and a portal server 102, an image formation apparatus 105, and a client personal computer (PC) 106, which are connected via a network (including local area network (LAN) 104 and WAN 101).

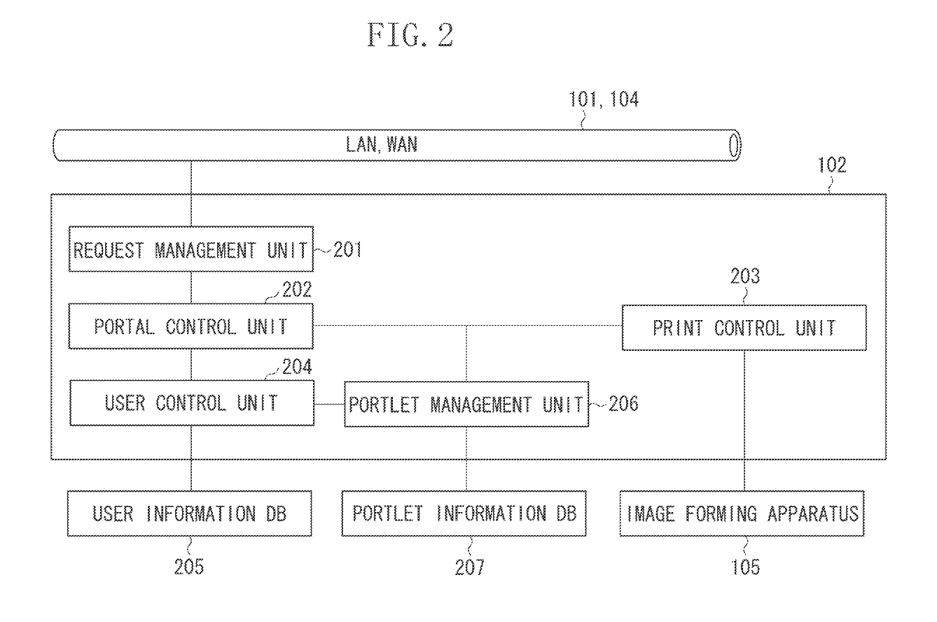

As illustrated in FIG. 2, the portal server 102 includes a portlet information DB 207 for recording an HTML file, an image file, and an object file such as a video, music, and voice file, and a user information DB 205 for recording user information. Also, the portal server 102 is connected to a plurality of Web servers and a plurality of client PCs via the network.

The portal server 102 obtains the object file from the Web server 103 in response to a request from the user of a portal page displayed on the client PC 106, and transfers the object file to the client PC 106. Here, the portal server 102 is capable of obtaining information requested by the user from a plurality of Web servers, and the obtained information is displayed as information of portlets on a Web browser of the client PC 106.

When the client PC 106 requests the portal server 102 of a portal page, the portal server 102 converts the object file obtained from the Web server 103 into a print job. The portal server 102 has a job processing function of transferring the print job to the image forming apparatus 105 connected to the LAN 104.

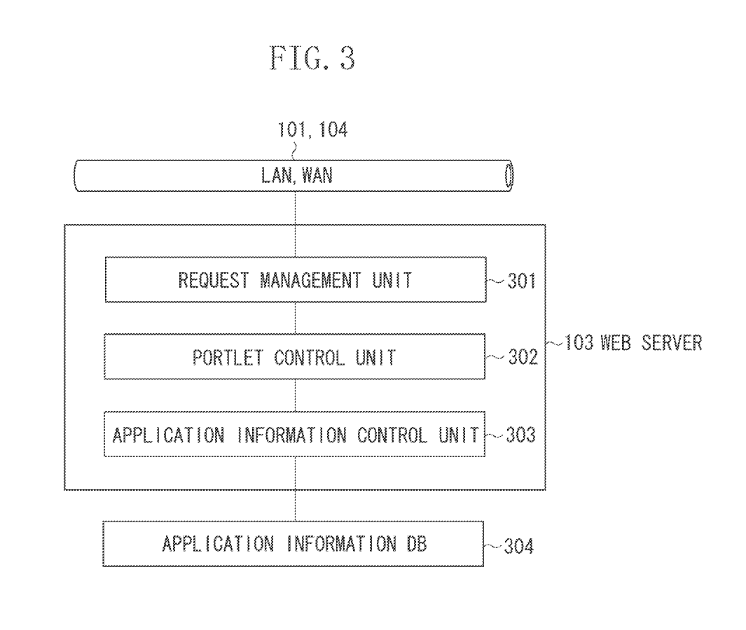

As illustrated in FIG. 3, the Web server 103 includes an application information DB 304 for storing an object file such as an HTML file, an image file, a video, a music, and voice file. The Web server 103 has a function of providing a desired object file to a requestor of the object file via the network. The requestor of the file includes the portal server 102.

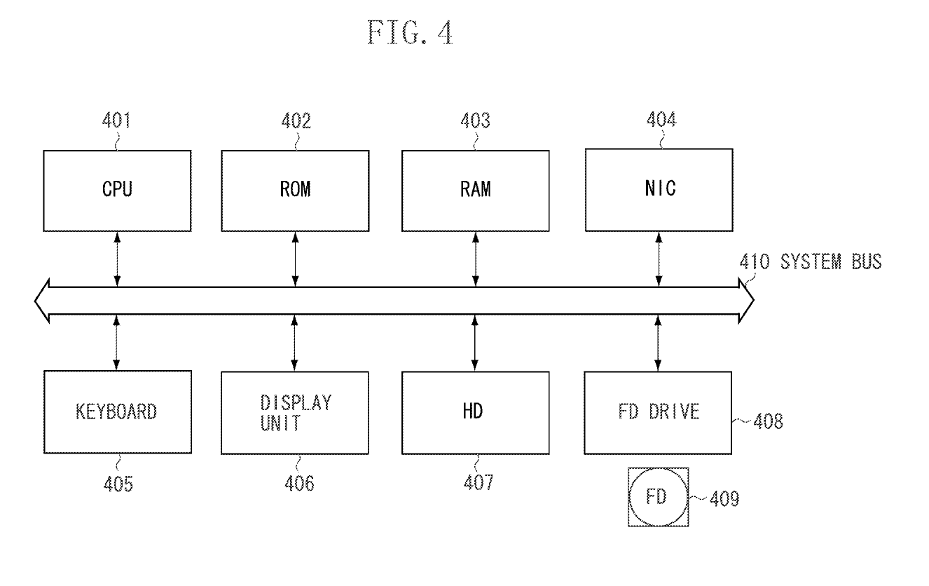

The client PC 106 includes a Web browser (software), and receives a desired object file via the network to display information of the portlet. The client PC described in the present exemplary embodiment includes hardware resources that are described below and illustrated in FIG. 4, and performs various pieces of data processing. However, the client PC may have a configuration of loading an application via the portal server 102 and performing a data processing.

The configuration may be modified such that the client PC 106 does not include a driver for the image forming apparatus 105, and that the portal server 102 generates a print job printable by the image forming apparatus 105 in response to a print request from the client server 106. Therefore, it is possible to adapt the present invention to a simple configuration in which the hardware to be included in the client PC 106 is the network communication function and the browser function.

The image forming apparatus 105 is connected to the LAN 104 and is a complex image forming apparatus provided with a printing device and a printing function, for example. The image forming apparatus 105 performs communication with the portal server 102 via the LAN 104, the WAN 101, and the like.

As the image forming apparatus 105, a printing device of various methods such as a laser beam printer employing electrophotography, an inkjet printer employing the inject method, and a printer employing thermal transfer method may be used.

The communication between apparatuses and devices included in the printing system may be wired communication using Ethernet (registered trademark) cable, or may be wireless communication utilizing electronic wave or light.

FIG. 2 is a block diagram illustrating a system configuration of the portal server 102 illustrated in FIG. 1. Referring to FIG. 2, a request management unit 201 sends/receives information to/from the Web server 103, the image forming apparatus 105, and the client PC 106 via the LAN 104 or the WAN 101.

A portal control unit 202 processes the information received from the request management unit 201, and controls a user control unit 204 and a portlet management unit 206. Also, the portal control unit 202 informs the Web server 103, the image forming apparatus 105, and the client PC 106 of information relating to a result of the processing via the request management unit 201.

A print control unit 203 processes the object file received from the Web server 103 to create a print job, and sends the print job to the image forming apparatus 105. The user control unit 204 communicates with a user information DB 205 to perform acquisition processing and storing processing such as setting of a portal page screen for displaying a portlet for each of the users and print settings.

The user information DB 205 is a database that stores information for each of the users as user information in which a user name, print settings, a print history, print position information for specifying a printed position when portlet information is printed, and the like are associated with one another.

The portlet management unit 206 communicates with a portlet information DB 207 to perform acquisition processing and storing processing for the information and settings of the portlet displayed on the portal page, and screen generation processing.

The portlet information DB 207 is a database storing information relating to the portlets.

FIG. 3 is a block diagram illustrating a system configuration of the Web server 103 illustrated in FIG. 1. Hereinbelow, a configuration of a module provided in the Web server 103 will be described.

Referring to FIG. 3, a request management unit 301 sends/receives information to/from the portal server 102 and sends information (including an object file) required for displaying and printing the portlet to the portal server 102 via the LAN 104 and the WAN 101.

A portlet control unit 302 controls an application information control unit 303 and a request management unit 301. The application information control unit 303 sends/receives information to/from the application information DB 304 and performs controls relating to processing for obtaining and storing information and settings required for the portlet function. The application information DB 304 is a database for storing information and settings required for the portlet function.

FIG. 4 illustrates a hardware configuration provided in the portal server 102, the Web server 103, and the client PC illustrated in FIG. 1. Unless otherwise described, it is of course possible to adapt the present exemplary embodiment to a single device or a system formed of a plurality of devices insofar as the function of the present exemplary embodiment is executed. Also, unless otherwise described, it is of course possible to adapt the present invention to a system in which processing is performed with a connection being established via a network such as a LAN and a WAN.

Referring to FIG. 4, a central processing unit (CPU) 401 is a control device for executing an application program, a print deriver program, an operating system (OS), and the portal control program according to the present exemplary embodiment stored in a hard disk (HD) 407.

The CPU 401 performs a control for temporarily storing information, a file, or the like required for executing the program, in a RAM 403. The CPU 401 opens various registered windows, and executes various pieces of data processing based on commands instructed by a mouse cursor or the like (not illustrated) on a display unit 406. The print settings and print instruction in the present exemplary embodiment are performed via the Web browser displayed on the display unit of the client PC.

A read-only-memory (ROM) 402 (storage unit) stores therein a program including a basic input/output (I/O) program and various pieces of data such as font data to be used for text processing and template data. The RAM 403, which is the temporary storage unit, functions as a main memory, a work area, or the like for the CPU 401. A network interface card (NIC) 404 is an I/O unit, and the information processing apparatus sends/receives data to/from an external device via the NIC 404.

A keyboard 405 is an instruction input unit to be used by the user for inputting instructions to the portal server 102 and the like. The display unit 406 is a display unit for displaying a command input from the keyboard 405 and a processing result of the command.

An external storage unit 407 is a hard disk (HD) functioning as a large capacity memory, and stores an application program, a print driver program, OS, and the like.

A floppy disk drive 408, which is a storage medium loading unit, is capable of loading a program or the like stored in a floppy disk (FD) 409, which is a storage medium, to the information processing apparatus. The storage medium is not limited to the FD and can arbitrarily be selected from a compact disk read-only memory (CD-ROM), compact disk recordable (CD-R), compact disk-rewritable (CD-RW), PC card, digital versatile disk (DVD), integrated circuit (IC) memory card, magneto optic disc (MO), memory stick, and the like.

In the floppy disk 409, which is the storage medium, a computer-readable program is stored.

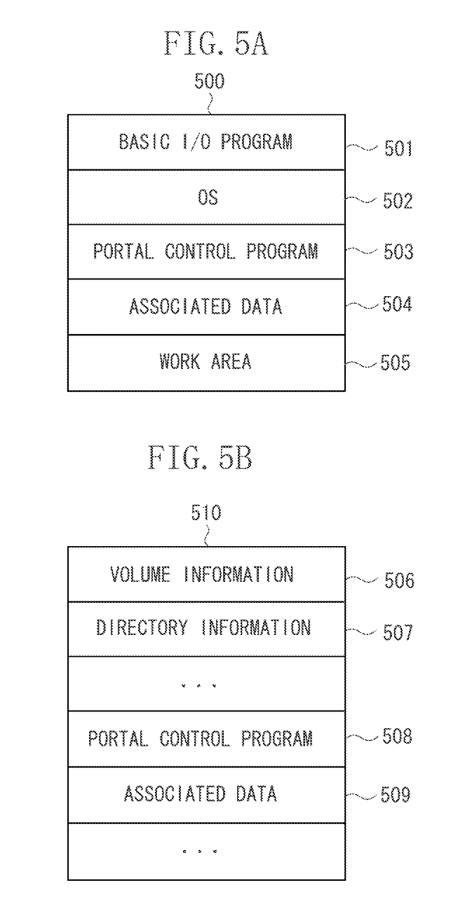

FIGS. 5A and 5B are diagrams illustrating an example memory map of the RAM 403 illustrated in FIG. 4. In the example, a portal control program loaded from the FD 409 to the RAM 403 is executable.

In the present exemplary embodiment, an example of loading the portal control program and associated data directly to the RAM 403 from the FD 409 for execution is described. Alternatively, the portal control program may be loaded to the RAM 403 from the HD 407 in which the portal control program has previously been stored.

Alternatively, the portal control program may be stored in the ROM 402 and formed to be a part of the memory map, so that the portal control program is directly executed by the CPU 401. Alternatively, software that realizes functions equivalent to those of the above-described devices may be used as a substitute for the hardware device.

Referring to FIG. 5A, a basic I/O program 501 causes the OS to be loaded from the HD 407 to the RAM 403 when power of the information processing apparatus is turned on. The basic I/O program 501 is a program corresponding to an initial program loading (IPL) function for starting operation of the OS.

A portal control program 503 of the present exemplary embodiment is stored in a region secured on the RAM 403. Association data 504 is stored in a region secured on the RAM 403. In a work area 505, a region for the CPU 401 to execute the portal control program is secured.

Referring to FIG. 5B, a memory map 510 is an example of the memory map of the FD 409 illustrated in FIG. 4, and represents contents of data of the FD 409. The memory map 510 has volume information 506 representing information of data, directory information 507, a portal control program 508 of the present exemplary embodiment, and association data 509.

The portal control program 508 is a program based on a flowchart to be described in the present exemplary embodiment, and the portal server 102 has the similar configuration in the present exemplary embodiment.

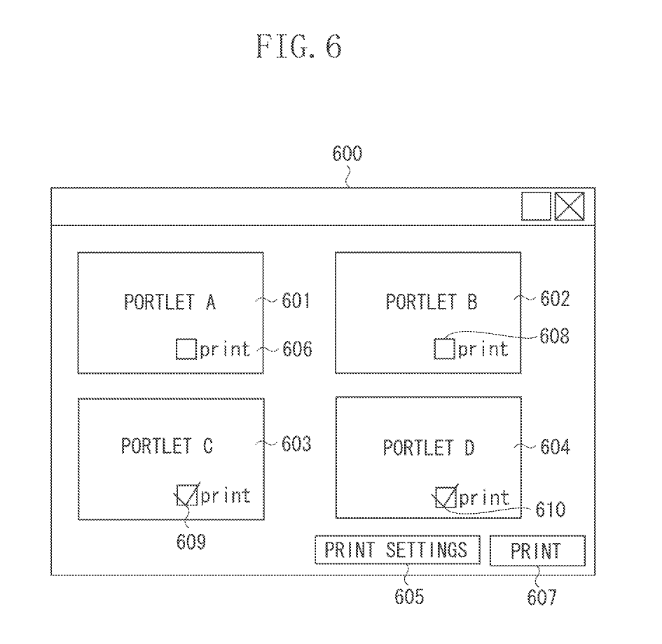

FIG. 6 is a diagram illustrating a screen configuration of a portal page displayed on the display unit 406 provided in the client PC 106 illustrated in FIG. 1.

Referring to FIG. 6, a portal page screen 600 is displayed on the display unit 406 by the Web browser of the client PC 106 when the client PC 106 accesses the portal server 102. The display mode is not more than one example, and other modes such as a scrollable screen may be displayed.

The portal page screen 600 is formed of a plurality of portlets, and information generated by the portal server 102 from the object file received from the Web server 103 is displayed on the Web browser of the client PC 106.

Portlets 601 to 604 are arranged on the portal page screen 600 to be operated on the Web server 103. The user operates the portlets 601 to 604 via the portal page screen 600 displayed on the display unit 406 by the Web browser or the like of the client PC 106 to perform operations such as displaying and editing, of a document.

The number of portlets to be displayed is determined by the number of portlets used by the user and not limited to the 4 portlets of the present exemplary embodiment.

In the present exemplary embodiment, print-designated buttons 606 and 608 to 610 for instructing printing are provided for each of the portlets 601 to 604. The portal server 102 retains check states of the print-designated buttons 606 and 608 to 610 for each of the users and determines whether contents of the portlet to which a print instruction is given are to be printed.

In the present exemplary embodiment, a check button is described as one example of a method for giving printing instruction to the portlet, but another equivalent unit may be employed.

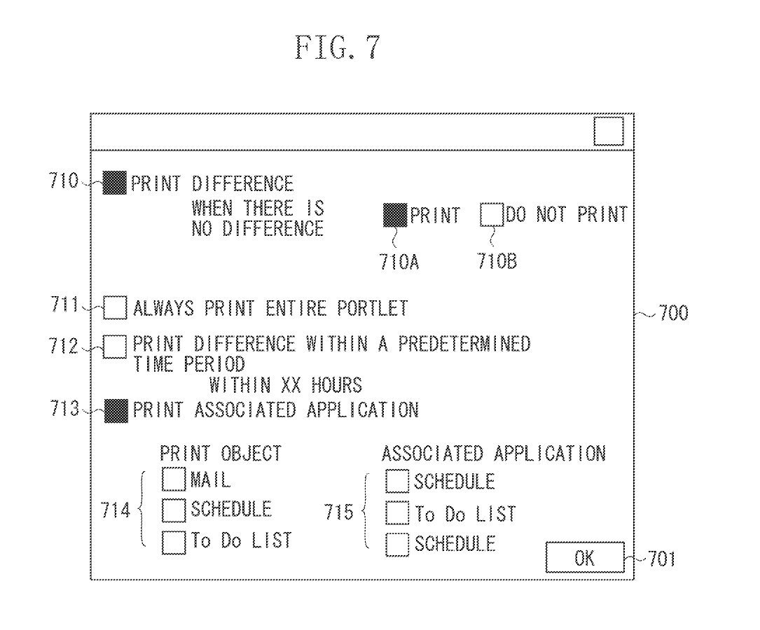

The print setting button 605 is a button for inputting print settings, and print setting screen 700 illustrated in FIG. 7 is displayed on the display unit 406 of the client PC 106 when the user operating the client PC 106 presses the print setting button 605.

Referring to FIG. 6, when the user of the client PC 106 presses the print button 607, the portal server 102 creates a print job from the information of the portlet that is checked by the user among the print instruction buttons 606 and 608 to 610. The print job created by the portal server 102 is sent to the image forming apparatus 105.

FIG. 7 is a diagram illustrating an example of the print setting screen 700 displayed on the display unit 406 provided in the client PC 106 illustrated in FIG. 1. Hereinbelow, print setting information according to the present exemplary embodiment will be described.

The screen is called up when the print setting button 605 displayed on the display unit 406 by the Web browser is pressed by the user. The user performs various operations on the Web browser, and set contents are retained in the user information DB 205 of the portal server 102 for each of the users.

A check 710 for designating difference printing is included in the print setting screen 700 illustrated in FIG. 7. When a portlet that has previously been printed is printed again, only the difference (i.e. unprinted information) from the previous print contents is printed by the user's instruction via the check 710.

When the user designates a check 710A, the portal server 102 generates a print job for printing a portlet designated by the user even when the portlet has no difference. When the portlet is a schedule application, for example, “difference” means information specifying a previously printed print position.

In the present exemplary embodiment, when date of the schedule application currently obtained is updated based on date and time, information corresponding to a time period between the previous update date and time and the current update date and time is extracted as the difference to be printed.

When the user designates a check 710B, the portal server 102 does not print a portlet designated by the user when there is no difference in the portlet. In short, no print job is generated.

When a check 711 is checked by the user operating the client PC 106, the portal server 102 generates a print job for printing an entire portlet that is designated to be printed irrespective of presence/absence of a difference of information in the portlet.

Hereinbelow, the case in which a check 712 is checked by the user operating the client PC 106 and time XX is designated will be described.

The portal server 102 generates a print job for printing a difference between the previous update date and time and the current update date and time when a time elapsed from the previous printing of the portlet is within a predetermined time (XX hours). As “XX time”, the user may set an arbitrary time interval by the unit of hour or minute.

When a check 713 is checked by the user operating the client PC 106, it is possible for the user of the client PC 106 to simultaneously set one or more print objects 714 and one or more applications 715.

For example, when the applications corresponding to the check buttons 608 to 610 are mail, schedule, and “To Do list”, the following association is available. In the present exemplary embodiment, it is possible to set the association applications 715 as the applications to be associated with the print objects 714.

In the present exemplary embodiment, the example of associating the schedule to the mail, the “To Do list” to the schedule, and the schedule to the “To Do list” is described. An OK button 701 functions as a button for confirming the set contents. When the OK button 701 is pressed, the contents set in the print setting screen 700 are managed by the user information DB 205 in the portal server 102. In the present exemplary embodiment, it is possible to set the print contents, the associated application to be simultaneously printed, and the like by pressing the print setting button 605. In the following description, a print job creation processing when there is a difference in information of a portlet obtained from the Web server 103 will be described.

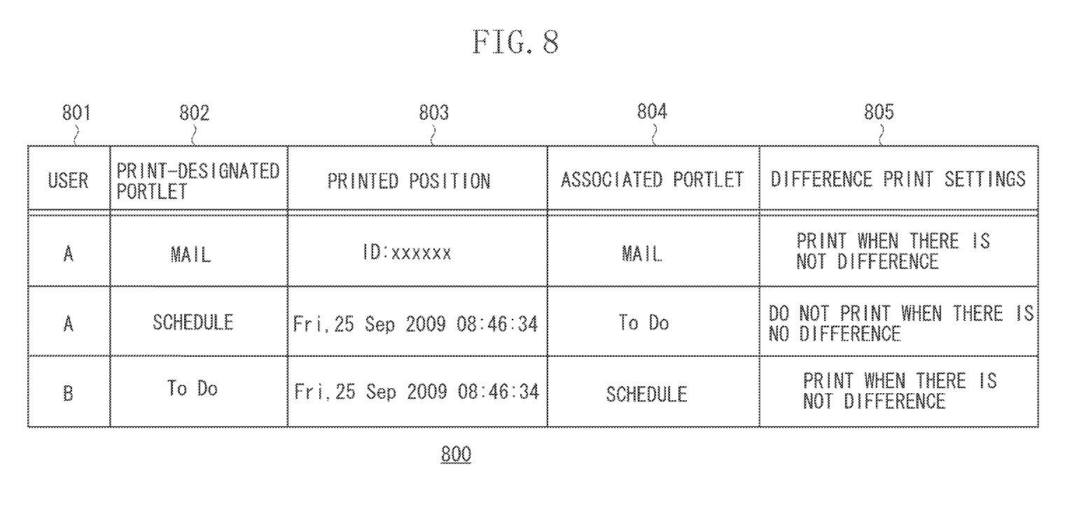

FIG. 8 is a diagram illustrating user information 800 retained in the user information DB 205 illustrated in FIG. 1.

Referring to FIG. 8, a user name 801 is information for specifying the user of the client PC 106 viewing the portal page. A print-designated portlet 802 is a portlet checked via the print-designated buttons 606 and 608 to 610 described with reference to FIG. 6.

When any one of the print-designated buttons is checked by the user, the portal server 102 obtains information of the portlet registered in a state associated with any one of the print-designated buttons 606 and 608 to 610 from the Web server 103. The portal server 102 refers to the information obtained from the Web server 103 and print position information described below to determine whether there is a difference due to update of the information of the portlet.

A printed position 803 is information indicating which part of the contents of the portlet is printed, and managed for each of the users. In the present exemplary embodiment, an example in which a date or an ID is retained in the user information DB 205 to be managed as the printed position information indicating the printed position 803 is described.

The portal server 102 updates the printed position 803 every time the printing is terminated, and the printed information 803 is referred to by the portlet control unit 302 at the next print instruction. Also, the printed position 803 is referred to by the portlet control unit 302 in the case of determining whether there is a difference between the previous print contents and the current information contents of the portlet.

Hereinbelow, information retained in the portlet information DB 207 will be described. For example, date information is retained in the case of a portlet hourly displaying an article or contents of a mail, and an ID for specifying a position of a document is retained in the case of a portlet having the ID.

A configuration of retaining another information for specifying a position of a document as the information to be retained in the portlet information DB 207 may be adapted.

An associated portlet 804 is a portlet to be printed together with the portlet designated by the print-designated portlet 802 when the information of the designated portlet is printed.

It is possible to set a plurality of associated portlets simultaneously, and contents of the plurality of associated portlets are printed in the same manner. However, when there is a plurality of associated portlets for one portlet, the portlets to be printed can be overlapped. Therefore, the portal control unit 202 deletes information of the overlapping portlets in printing according to a flow of the flowchart described below, so that waste of overlapping printing otherwise entailed is saved.

The associated portlet 804 is designated on the print setting screen 700 by the user operating the client PC 106, and the designated contents are retained in the associated portlet 804 of the user information DB 205 by the portal server 102. Set information corresponding to the checks 710 to 712 on the print setting screen 700 illustrated in FIG. 7 is retained in the user information DB 205 as difference print settings 805.

When the user who has logged in the client PC 106 checks the check 710 on the print setting screen 700, settings including print when there is no difference and the like are retained in the difference print settings 805 of the user information DB 205.

Likewise, the user who has logged in the client PC 106 checks the check 711 on the print setting screen 700, settings for printing information corresponding to an entire portlet is retained in the difference print settings 805 of the user information DB 205.

Likewise, the user who has logged in the client PC 106 checks the check 712 on the print setting screen 700, settings for printing a difference of information corresponding to a portlet is retained in the difference print settings 805 of the user information DB 205.

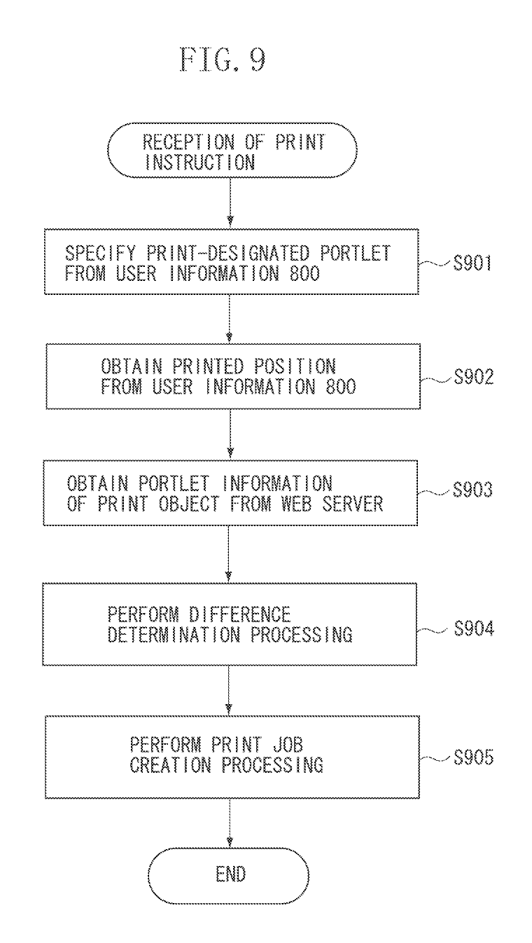

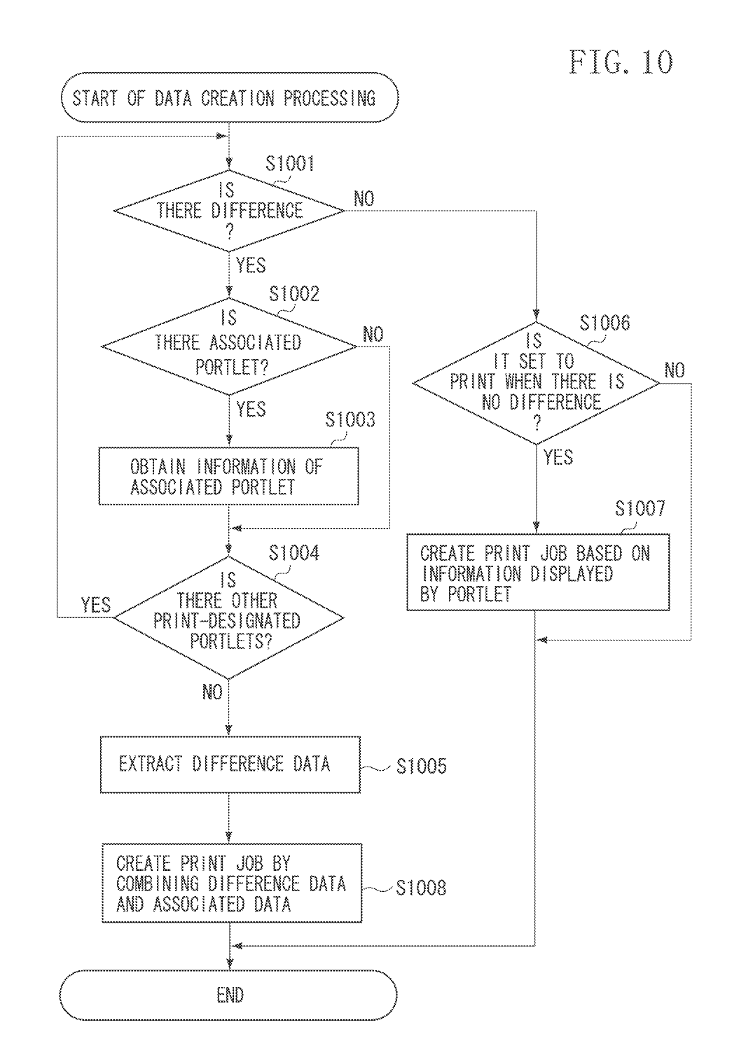

Hereinbelow, print processing of the portal server 102 according to the present exemplary embodiment will be described referring to flowcharts of FIGS. 9 and 10.

FIG. 9 is the flowchart illustrating the print processing of the information processing apparatus according to the present exemplary embodiment. The present exemplary embodiment corresponds to a print processing procedure when the portal server 102 receives a print instruction via the Web browser of the client PC 106.

A program of the portal server 102 according to the flowchart of the present exemplary embodiment is stored in the HD 407 of the portal server 102, read out by the RAM 403, and executed by the CPU 401 of the portal server 102.

The program of the portal server 102 includes the program for causing the devices 201 to 206 illustrated in FIG. 2 to function. Therefore, the program that is executed by the CPU 401 of the portal server 102 for causing the devices 201 to 206 illustrated in FIG. 2 to function will be mainly described in the following description.

In step S901, the portal control unit 202 obtains user information 800 of the user who has issued the print instruction using the client PC 106 from the user information DB 205.

The portal control unit 202 specifies the print-designated portlet 802 of the user from the obtained user information 800. For example, when the user who has issued the print instruction is the user B, the “To Do list” is specified as the print-designated portlet based on FIG. 8.

In step S902, the portal control unit 202 obtains from the user information DB 205 the printed position 803 corresponding to the print-designated portlet 802 obtained in step S901.

In step S903, the portal control unit 202 obtains an object file of the print-designated portlet 802 from the Web server 103 via the request management unit 201.

In step S904, the portal control unit 202 determines whether there is a difference between information of the portlet of the previous printing and current information of the portlet from the printed position 803 corresponding to the object file obtained in step S903 and the print-designated portlet 802.

In the determination of difference, a text file described in a markup language such as HTML is analyzed, and a date of a document described in the text file and the printed position 803 are compared with each other, thereby determining that there is a difference when there is a document having a date newer than the printed position 803.

In step S905, the print control unit 203 creates a print job that is printable by the image forming apparatus 105 based on the information received from the portal control unit 202 and the difference print settings 805 of the user information DB 205, and then the processing ends. The processing for creating the print job will be described with reference to FIG. 10 below.

FIG. 10 is a flowchart illustrating print processing of the information processing apparatus according to the present exemplary embodiment. The present example is one example of a print job creating processing procedure when the portal server 102 receives a print instruction via the Web browser operated by the user of the client PC 106.

In step S1001, the portal control unit 202 determines whether there is a difference between the portlet information of the previous printing and the current portlet information performed in step S904. When the portal control unit 202 determines that there is a difference (YES in step S1001), the processing proceeds to step S1002. When the portal control unit 202 determines that there is no difference (NO in step S1001), the processing proceeds to step S1006.

In step S1002, the portal control unit 202 obtains from the user information DB 205 the associated portlet 804 of the portlet specified in step S901. The portal control unit 202 determines whether the associated portlet 804 is set for the identified user.

When the portal control unit 202 determines that the associated portlet 804 is set for the identified user (YES in step S1002), the processing proceeds to step S1003. On the other hand, when there is no setting (NO in step S1002), the processing proceeds to step S1004.

In step S1003, the portal control unit 202 obtains from the Web server 103 an object file corresponding to the associated portlet 804 obtained in step S1002.

In step S1004, the portal control unit 202 obtains from the user information DB 400 an unprocessed designated portlet in the designated portlet 802 of the user who has issued the print instruction. The portal control unit 202 determines whether there is other print-designated portlets 802 of the user based on the designated portlet 802 obtained from the user information DB 205.

When the portal control unit 202 determines that there is other print-designated portlets 802 (YES in step S1004), the processing of steps S1001 to S1004 is repeated. Thus, it is possible to determine whether a difference exists in the information to be printed for each of the print-designated portlets.

When the portal control unit 202 determines that any other print-designated portlets 802 do not exist (NO in step S1004), the processing proceeds to step S1005. In step S1005, the print control unit 203 extracts the difference data to be printed in the print-designated portlet from the object file obtained and the printed position 803 obtained in step S903.

As a simple example of the difference extraction, a method of analyzing a text file described in a markup language such as HTML in the same manner as in the difference determination in step S904 and extracting a part to be printed based on the printed position 803 can be used.

In step S1008, the object file of the associated portlet obtained in step S1003 and the difference data extracted in step S1005 are combined to create a print job printable by the image forming apparatus 105, and then, the processing ends.

In step S1001, when the portal control unit 202 determines that there is no difference data (NO in step S1001), the processing proceeds to step S1006. In step S1006, the portal control unit 202 obtains the difference print settings 805 of the user information 800 from the user information DB 205 to determine whether it is set to print even when there is no difference.

In step S1006, when the portal control unit 202 determines that the printing when there is no difference is not set (NO in step S1006), the processing ends. On the other hand, when the portal control unit 202 determines that the printing even when there is no difference is set (YES in step S1006), the processing proceeds to step S1007. In step S1007, the print control unit 203 creates a print job printable by the image forming apparatus 105 from the object obtained from the Web server 103 in step S903. Then, the processing ends.

According to the present exemplary embodiment, the portal server creates one print job by automatically combining the difference to be printed in each of the portlets and the contents of the associated portlet. Thus, the conventional work of performing print-designated for each of the portlets is eliminated, and it is possible for the user to correctly obtain only the necessary information as the print result.

In the present exemplary embodiment, entire information of the associated portlet (not a difference of the associated portlet) is printed. For example, when the associated portlet is the schedule and the print-designated portlet is the “To Do list”, since the entire information of the associated portlet is printed, it is possible for the user to determine a next work while understanding the entire schedule. Since the above-described case is presumed, the entire information of the associated portlet is printed.

However, some of the users may desire to print only a difference of the associated portlet. Therefore, a print job for printing only differences of a print-designated portlet and an associated portlet may be generated depending on a user's instruction. In such a case, a printed position of the associated portlet is stored in the user information DB.

In a second exemplary embodiment describes printing of an associated portlet that is different from a print-designated portlet together with the print-designated portlet as contrasted with the first exemplary embodiment. In this case, information to be printed can be overlapped in the portlets associated to one another. Therefore, when the information to be printed is overlapped, the overlapping information is deleted when creating the print job.

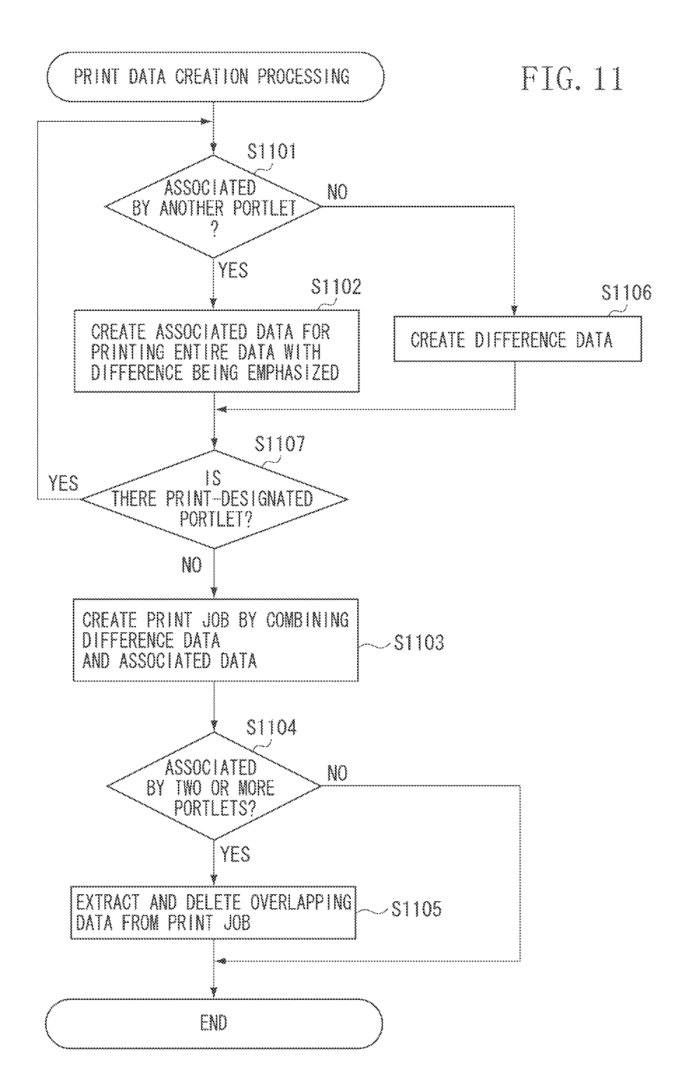

Hereinbelow, a print processing of the portal server 102 according to the present exemplary embodiment will be described by referring to the flowchart of FIG. 11.

In the present exemplary embodiment, a system configuration, a server configuration, and configurations of applications are the same as those of the first exemplary embodiment. Also, in the flow of the processing, the processing until the data creation processing in step S905 is the same as that of the first exemplary embodiment.

FIG. 11 is a flowchart illustrating the print processing of the information processing apparatus according to the present exemplary embodiment. The present example is a print job creation processing procedure example when the print-designated portlet is set as the associated portlet 804 by another print-designated portlet when the print control unit 203 creates a print job.

In step S1101, the portal control unit 202 determines whether a print-designated portlet of a print instruction is set as an associated portlet by another print-designated portlet. More specifically, the portal control unit 202 determines whether there is the above-described associated portlet setting by searching associated portlets 804 of the user information 800 stored in the user information DB 205 via the user control unit 204.

For example, when a user A instructs printing in FIG. 8, the portlet of the schedule is the print-designated portlet and is also set as an associated portlet of the mail portlet. Therefore, in step S1101, it is determined that the schedule portlet is set as the associated portlet by another print-designated portlet.

When the portal control unit 202 determines that the print-designated portlet is set as the associated portlet 804 by another print-designated portlet (Yes in step S1101), the processing proceeds to step S1106. The processing proceeds to step S1106 when the portal control unit 202 determines otherwise (No in step S1101).

In step S1106, the print control unit 203 extracts data of a difference to be printed that does not contain previously printed data from the object file obtained from the Web server 103 in step S903 and the printed position 803. The print control unit 203 creates a print job printable by the image forming apparatus 105 from the extracted difference data, and the processing proceeds to step S1107.

In step S1102, the print control unit 203 creates association data by which entire data of the print-designated portlet of the determination object are printed with the difference being emphasized based on the object file of the print-designated portlet and the printed position 803 of the determination object in step S1101.

For example, when the user A instructs printing in FIG. 8, the entire data of the schedule portlet are printed as the associated portlet with the difference data being printed distinguishably in the entire data as the print-designated portlet.

In step S1107, the portal control unit 202 determines whether a print-designated portlet of which data is not created exists. More specifically, the portal control unit 202 searches for the print-designated portlet 802 of the user information 800 stored in the user information DB 205 via the user control unit 204.

The processing proceeds to step S1103 when the portal control unit 202 determines that the print-designated portlet of which the data is not created do not exist (NO in step S1107). On the other hand, the processing after step S1101 is performed when it is determined that the unprocessed print-designated portlet exists (Yes in step S1107).

In step S1103, the print control unit 203 creates a print job by combining the object file obtained from the Web server 103 in step S1003, the extracted difference data of all of the print-designated portlets, and the associated data created in step S1102.

For example, when the user A instructs printing in FIG. 8, the difference data of the mail, the entire data of the schedule, and the entire data of the “To Do list” are printed. In the printing of the entire data of the schedule, data without difference and difference data are distinguishably printed. More specifically, a method of printing the data without difference and the difference data by using different colors or different densities may be employed.

In step S1104, the portal control unit 202 determines whether the print-designated portlet is set as the associated portlet by two or more of other print-designated portlets as a result of the search in step S1101. When the portal control unit 202 determines that the print-designated portlet is set as the associated portlet by two or more of other print-designated portlets (YES in step S1104), the processing proceeds to step S1105. On the other hand, when the setting does not exist (No in step S1104), the processing ends.

In step S1105, the print control unit 203 extracts the overlapping data to delete the overlapping data from the created print job. Then, the processing ends.

According to the present exemplary embodiment, even when the print-designated portlet is associated with another portlet, printing of wasteful contents is prevented, and the user is enabled to obtain a well-formed print result of the necessary portlet information.

The present invention is realized by performing the following processing, i.e., processing of supplying software (program) realizing the functions of the above-described exemplary embodiments to a system or an apparatus via a network or various storage mediums and causing a computer (CPU or micro processing unit (MPU)) of the system or the apparatus to read out and execute the program.

The present invention is not limited to the above-described exemplary embodiments. Various modifications (including organic combinations of the exemplary embodiments) based on the spirit of the present invention are possible, and the modifications are not excluded from the scope of the present invention.

Various examples and exemplary embodiments of the present invention are described above, and it is apparent for those skilled in the art that the spirit and scope of the present invention are not limited to the specific description of the present specification. According to the present invention, the user is enabled to print information of an unprinted portlet by a simple operation.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-007888 filed Jan. 18, 2010, which is hereby incorporated by reference herein in its entirety.

What is claimed is:

1. An information processing apparatus providing to a client device a portal page in which a plurality of portlets is aggregated, the information processing apparatus comprising:
a retaining unit configured to retain print position information for specifying printed information in each of the plurality of portlets;
a designation unit configured to designate a print-designated portlet as a print object from the plurality of portlets aggregated in the portal page;
a determination unit configured to determine whether unprinted information is contained in information required for printing the print-designated portlet based on the information required for printing the print-designated portlet designated by the designation unit and the print position information; and
a creation unit configured to create a print job in such a manner that the unprinted information of the portlet is printed when the determination unit determines that the unprinted information is contained in information required for printing the print-designated portlet.

2. The information processing apparatus according to claim 1, wherein the designation unit designates a portlet to be printed together with the print-designated portlet as an associated portlet, and the creation unit creates the print job in such a manner that the unprinted information of the print-designated portlet and information of the associated portlet are printed.

3. The information processing apparatus according to claim 1, wherein the creation unit creates a print job in which the printed information and the unprinted information are distinguishable from each other in entire information of the print-designated portlet when the print-designated portlet designated by the designation unit is designated as an associated portlet of another print-designated portlet.

4. A job processing method in an information processing apparatus for providing to a client device a portal page in which a plurality of portlets is aggregated, the job processing method comprising:
retaining print position information for specifying printed information in each of the plurality of portlets in a retaining unit;
designating a print-designated portlet as a print object from the plurality of portlets aggregated in the portal page;
determining whether unprinted information is contained in information required for printing the print-designated portlet based on the information required for printing the designated print-designated portlet and the print position information; and
creating a print job in such a manner that the unprinted information of the portlet is printed when it is determined that the unprinted information is contained in information required for printing the print-designated portlet.

5. The job processing method according to claim 4, wherein
designating a portlet to be printed together with the print-designated portlet as an associated portlet, and
creating the print job in such a manner that the unprinted information of the print-designated portlet and information of the associated portlet are printed.

6. The job processing method according to claim 4, wherein
creating a print job in which the printed information and the unprinted information are distinguishable from each other in entire information of the print-designated portlet when the designated print-designated portlet is designated as an associated portlet of another print-designated portlet.

7. A non-transitory computer-readable storage medium storing a program that causes an information processing apparatus that provides to a client device a portal page in which a plurality of portlets is aggregated to function as:
a retaining unit configured to retain print position information for specifying printed information in each of the plurality of portlets;
a designation unit configured to designate a print-designated portlet as a print object from the plurality of portlets aggregated in the portal page;
a determination unit configured to determine whether unprinted information is contained in information required for printing the print-designated portlet based on the information required for printing the print-designated portlet designated by the designation unit and the print position information; and
a creation unit configured to create a print job in such a manner that the unprinted information of the portlet is printed when the determination unit determines that the unprinted information is contained in information required for printing the print-designated portlet.
